(19) United States
(12) Patent Application Publication
(10) Pub. No.: US 2017/0018062 A1
(43) Pub. Date: Jan. 19, 2017

(54) IMAGE PROCESSING DEVICES AND IMAGE PROCESSING METHODS

(71) Applicant: Agency for Science, Technology and Research, Singapore (SG)

(72) Inventors: Zhengguo LI, Singapore (SG); Zijian ZHU, Singapore (SG); Jinghong ZHENG, Singapore (SG)

(73) Assignee: Agency for Science, Technology and Research, Singapore (SG)

(21) Appl. No.: 15/301,032

(22) PCT Filed: Mar. 31, 2015
(86) PCT No.: PCT/SG2015/000105

§ 371 Date: Sep. 30, 2016

(30) Foreign Application Priority Data
Mar. 31, 2014 (SG) 10201401120T

(51) Int. Cl. G06T 5/00; G06T 5/50; H04N 9/12; H04N 1/60

(52) U.S. Cl. CPC G06T 5/009; H04N 1/6027; G06T 5/50; H04N 9/12; G06T 2207/20221; G06T 2207/20208; G06T 2207/10024; G06T 2207/10144

(57) ABSTRACT

According to various embodiments, an image processing device may be provided. The image processing device may include: an input circuit configured to receive input image data including pixels related to varying exposure times; a selecting circuit configured to select a reference image from the input images; a weighting determination circuit configured to determine at least one weighting for each pixel of the input image data based on the selected reference image; an output image determination circuit configured to determine an output image based the determined weightings; and an output circuit configured to output the output image.

### CROSS-REFERENCE TO RELATED APPLICATIONS

The present application claims the benefit of the Singapore patent application No. 10201401120T filed on 31 Mar. 2014, the entire contents of which are incorporated herein by reference for all purposes.

### TECHNICAL FIELD

Embodiments relate generally to image processing devices and image processing methods.

### BACKGROUND

One of the challenges in digital image processing research is the rendering of a high dynamic range (HDR) natural scene on a conventional low, dynamic range (LDR) display. Thus, there may be a need for efficient devices and methods for providing HDR scenes.

### SUMMARY

According to various embodiments, an image processing device may be provided. The image processing device may include: an input circuit configured to receive input image data including pixels related to varying exposure times; a selecting circuit configured to select a reference image from the input images; a weighting determination circuit configured to determine at least one weighting for each pixel of the input image data based on the selected reference image; an output image determination circuit configured to determine an output image based the determined weightings; and an output circuit configured to output the output image.

According to various embodiments, an image processing method may be provided. The image processing method may include: receiving input image data including pixels related to varying exposure times; selecting one of the input images as a reference image; determining at least one weighting for each pixel of the input image data; determining an output image based the determined weightings; and outputting the output image.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments are described with reference to the following drawings, in which:

FIG. 1A shows an image processing device according to various embodiments;

FIG. 1B shows a flow diagram illustrating an image processing method according to various embodiments;

FIG. 2 shows an illustration of an image with three row-wise different exposures;

FIG. 3A, FIG. 3B, and FIG. 3C show illustrations of three basic Bayes color filter arrays with different exposures; and

FIG. 4A, FIG. 4B, and FIG. 4C show illustrations of three additional basic Bayes color filter arrays with different exposures.

### DESCRIPTION

Embodiments described below in context of the devices are analogously valid for the respective methods, and vice versa. Furthermore, it will be understood that the embodiments described below may be combined, for example, a part of one embodiment may be combined with a part of another embodiment.

In this context, the image processing device as described in this description may include a memory which is for example used in the processing carried out in the image processing device. A memory used in the embodiments may be a volatile memory, for example a DRAM (Dynamic Random Access Memory) or a non-volatile memory, for example a PROM (Programmable Read Only Memory), an EPROM (Erasable PROM), EEPROM (Electrically Erasable PROM), or a flash memory, e.g., a floating gate memory, a charge trapping memory, an MRAM (Magnetoresistive Random Access Memory) or a PCRAM (Phase Change Random Access Memory).

In an embodiment, a “circuit” may be understood as any kind of a logic implementing entity, which may be special purpose circuitry or a processor executing software stored in a memory, firmware, or any combination thereof. Thus, in an embodiment, a “circuit” may be a hard-wired logic circuit or a programmable logic circuit such as a programmable processor, e.g. a microprocessor (e.g. a Complex Instruction Set Computer (CISC) processor or a Reduced Instruction Set Computer (RISC) processor). A “circuit” may also be a processor executing software, e.g. any kind of computer program, e.g. a computer program using a virtual machine code such as e.g. Java. Any other kind of implementation of the respective functions which will be described in more detail below may also be understood as a “circuit” in accordance with an alternative embodiment.

One of the challenges in digital image processing research may be the rendering of a high dynamic range (HDR) natural scene on a conventional low dynamic range (LDR) display. This challenge may be addressed by capturing multiple LDR images at different exposure levels. Each LDR image may only record a small portion of the dynamic range and partial scene details but the whole set of LDR images collectively may contain all scene details. There are various methods to synthesize a more detailed and natural image from the differently exposed LDR images. One is called HDR imaging. A HDR image is first synthesized to include details of all input images. It is then converted into an LDR image by using tone mapping algorithm so as to visualize the HDR scene by conventional display device. The other is called exposure fusion. An LDR image is directly synthesized from all LDR images without generation of an intermediate HDR image.

According to various embodiments, devices and methods may be provided for fusion of multiple differently exposed images and recovering an HDR radiance map from multiple differently exposed images. One of differently exposed images may be selected as the reference image. According to various embodiments, the longest exposed image without motion blurring artefacts may be selected as the reference image. A similarity weighting may be assigned to each pixel in other images according to the consistence between the pixel and its collocates pixel in the selected reference image. According to various embodiments, the similarity weighting may approach 1 if they are consistent and 0 otherwise. It is to be noted that the similarity weightings are 1's for all pixels in the reference image. According to various embodiments, ghosting artefacts may be avoided when there are moving objects in differently exposed images. Even if differently exposed images are captured by advanced HDR systems, possible motion blurring artefacts in the long exposed image may be avoided from appearing in the final image.

According to various embodiments, devices and methods for ghosting and motion blurring artefacts free HDR imaging and exposure fusion may be provided.

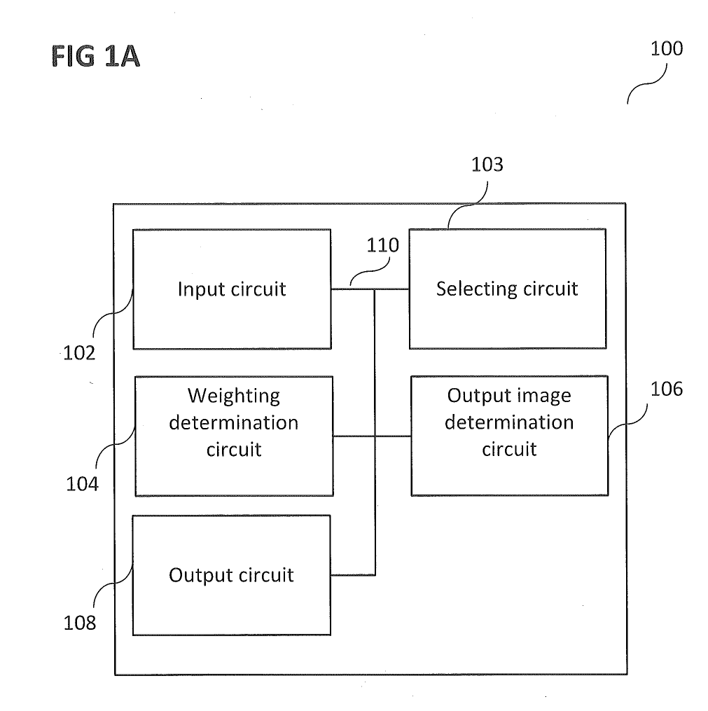

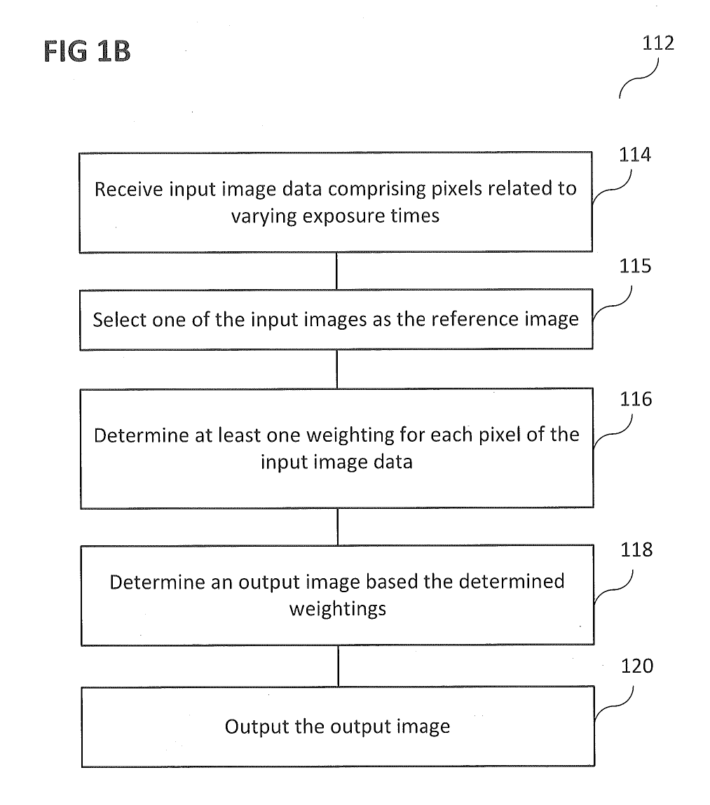

FIG. 1A shows an image processing device 100 according to various embodiments. The image processing device 100 may include an input circuit 102 configured to receive input image data including pixels related to varying exposure times. The image processing device 100 may further include a selecting circuit 103 configured to select a reference image from the input images. The image processing device 100 may further include a weighting determination circuit 104 configured to determine at least one weighting for each pixel of the input image data, for example based on the selected reference image. The image processing device 100 may further include an output image determination circuit 106 configured to determine an output image based the determined weightings. The image processing device 100 may further include an output circuit 108 configured to output the output image. The input circuit 102, the selecting circuit 103, the weighting determination circuit 104, the output image determination circuit 106, and the output determination circuit 108 may be coupled with each other, like indicated by lines 110, for example electrically coupled, for example using a line or a cable, and/or mechanically coupled.

In other words, according to various embodiments, an image processing device may determine at least one a weighting for each pixel of a plurality of pixels which correspond to various exposure times, and may determine an output image based on the at least one weighting for each pixel.

According to various embodiments, the weighting determination circuit 104 may be configured to determine an exposedness level weighting.

According to various embodiments, the exposedness level weighting may be large if a pixel is well exposed.

According to various embodiments, the exposedness level weighting may be small if a pixel is at least one of underexposed or overexposed.

According to various embodiments, the weighting determination circuit 104 may be configured to determine a similarity weighting.

According to various embodiments, the similarity weighting may be close to one if collocated pixels in two images are consistent.

According to various embodiments, the similarity weighting may be close to zero if collocated pixels in two images are not consistent.

According to various embodiments, the output image determination circuit 106 may be configured to determine the output image based on a radiance map.

According to various embodiments, the input image data may include or may be an input image including rows, wherein the exposure time varies amongst the rows.

According to various embodiments, the input image data may include or may be a plurality of images, wherein each image of the plurality of images has an exposure time, wherein the exposure time varies amongst the images of the plurality of images.

According to various embodiments, the image processing device 100 may be configured to convert an input image of the input image data from RGB color space to CIELab color space.

According to various embodiments, the image processing device 100 may be configured to fuse a lightness component of the converted image using a multi-scale method and to fuse color component of the converted image via a single-scale method.

FIG. 1B shows a flow diagram 112 illustrating an image processing method according to various embodiments. In 114, input image data including pixels related to varying exposure times may be received. In 115, one of the input images may be selected as a reference image. In 116, at least one weighting for each pixel of the input image data may be determined, for example based on the selected reference image. In 118, an output image may be determined based the determined weightings. In 120, the output image may be output.

According to various embodiments, the at least one weighting may include or may be an exposedness level weighting.

According to various embodiments, the exposedness level weighting may be large if a pixel is well exposed.

According to various embodiments, the exposedness level weighting may be small if a pixel is at least one of underexposed or overexposed.

According to various embodiments, the at least one weighting may include or may be a similarity weighting.

According to various embodiments, the similarity weighting may be close to one if collocated pixels in two images are consistent.

According to various embodiments, the similarity weighting may be close to zero if collocated pixels in two images are not consistent.

According to various embodiments, the image processing method may further include determining the output image based on a radiance map.

According to various embodiments, the input image data may include or may be an input image including rows, wherein the exposure time varies amongst the rows.

According to various embodiments, the input image data may include or may be a plurality of images, wherein each image of the plurality of images has an exposure time, wherein the exposure time varies amongst the images of the plurality of images.

According to various embodiments, the image processing method may further include converting an input image of the input image data from RGB color space to CIELab color space.

According to various embodiments, the image processing method may further include fusing a lightness component of the converted image using a multi-scale method and fusing color components of the converted image via a single-scale method.

In the following, HDR imaging with a reference image according to various embodiments will be described.

Let Zᵢ(1≦i≦N) be a set of differently exposed images with N being the number of input images. The exposure time of Zᵢ is ∇tᵢ. Let p be a pixel. For simplicity, let i₀ be the selected reference image.

According to various embodiments, the pixel Zᵢ (p) may be assigned a weighting w₁ (Zᵢ (p)) to measure the exposedness level of Zᵢ (p). The value of w₁ (Zᵢ (p)) may be large if the pixel Zᵢ (p) is well exposed and small if it is over/under-exposed. Besides the weighting w₁ (Zᵢ (p)), the pixel Zᵢ (p) may be assigned another weighting w₂ (Zᵢ (p), Zᵢ_{₀} (p)) to measure the consistence between the pixel Zᵢ (p) and the pixel Zᵢ_{₀} (p). For simplicity, it is assumed that the value of ∇tᵢ_{₀} is larger than that of ∇tᵢ. Due to the different exposures of the images Zᵢ and Zᵢ_{₀}, there are possible large intensity changes between them. A bidirectional normalization method may be provided to normalize two collocated pixels Zᵢ (p) and Zᵢ_{₀} (p). The pixel Zᵢ_{₀} (p) may be mapped by using the intensity mapping functions (IMFs) from the image Zᵢ_{₀} to the image Zᵢ if it is not over-exposed. Otherwise, the pixel Zᵢ (p) may be mapped by using the IMFs from the image Zᵢ to the image Zᵢ_{₀}. Each color component may be mapped independently. The normalized pixels may then be adopted to compute the similarity weighting w₂ (Zᵢ (p), Zᵢ_{₀} (p)). The value of w₂ (Zᵢ_{₀} (p), Zᵢ_{₀} (p)) approaches 1 if the pixels Zᵢ (p) and Zᵢ_{₀} (p) are consistent and 0 otherwise. The value of w₂ (Zᵢ (p), Zᵢ_{₀} (p)) is always 1 for any pixel Zᵢ_{₀} (p).

According to various embodiments, the overall weighting of the pixel Zᵢ (p) may be

w_{f}(Zᵢ(p))=w₁(Zᵢ(p))w₂(Zᵢ(p),Zᵢ_{₀}(p)). (1)

Suppose that the CRF (camera response function) is f(.). The final HDR radiance map E(p) may be recovered as

$$E ( p ) = \frac{{\sum }_{i = 1}^{N} {w}_{f} ( {Z}_{i} ( p ) ) ( log ( {f}^{- 1} ( {Z}_{i} ( p ) ) ) - log ( ∇ {t}_{i} ) )}{{\sum }_{i = 1}^{N} {w}_{f} ( {Z}_{i} ( p ) )} , \qquad ( 2 )$$

where f⁻¹ (.) is the inverse CRF.

In the following, exposure fusion with a reference image according to various embodiments will be described.

According to various embodiments, the pixel Zᵢ(p) may be assigned a weighting w₃ (Zᵢ (p)) to measure its exposedness level and/or other quality levels such as good contrast, and high saturation. According to various embodiments, the pixel Zᵢ (p) may be assigned another weighting w₂ (Zᵢ(p), Zᵢ_{₀} (p)) to measure the consistence between the pixel Zᵢ (p) and the pixel Zᵢ_{₀} (p). According to various embodiments, the overall weighting of the pixel Zᵢ (p) may be computed as

w_{f}(Zᵢ(p))=w₃(Zᵢ(p))w₂(Zᵢ(p),Zᵢ_{₀}(p)). (3)

The image Zᵢ is converted from the RGB color space to the CIELab color space. Let Lᵢ, aᵢ and bᵢ be the lightness and color components of the image Zᵢ, respectively. According to various embodiments, only the lightness component may be fused using a multi-scale method like described in the following.

L{Lᵢ(p)}^{l} and G{w_{f}(Zᵢ(p))}^{l} are Laplacian pyramid of image Lᵢ and Gaussian pyramid of weight map w_{f}(Zᵢ(p)), respectively. Pixel intensities in the different pyramid levels may be blended as

$$L {\{ {L}_{f} ( p ) \}}^{l} = {\sum }_{i = 1}^{N} [ L {\{ {L}_{i} ( p ) \}}^{l} G {\{ {w}_{f} ( {Z}_{i} ( p ) ) \}}^{l} ] . \qquad ( 4 )$$

According to various embodiments, the pyramid L{L_{f}(p)}^{l} may be collapsed to produce the final lightness component L_{f}(p). The final color components may be determined via a single-scale method as

$${a}_{f} ( p ) = \frac{{\sum }_{i = 1}^{N} {w}_{f} ( {Z}_{i} ( p ) ) {a}_{i} ( p )}{{\sum }_{i = 1}^{N} {w}_{f} ( {Z}_{i} ( p ) )} , \\ {b}_{f} ( p ) = \frac{{\sum }_{i = 1}^{N} {w}_{f} ( {Z}_{i} ( p ) ) {b}_{i} ( p )}{{\sum }_{i = 1}^{N} {w}_{f} ( {Z}_{i} ( p ) )} . \qquad ( 5 )$$

In the following, a coded reset architecture for capturing of differently exposed images according to various embodiments will be described.

Differently exposed images may be captured by using the global shutter. This method performs well for a static HDR scene while it suffers from ghosting artifacts due to moving objects and motion blurring artifacts due to camera movement. A row-wise readout architecture called coded rolling shutter may be provided for complementary metal-oxide semiconductor (CMOS) image sensors and the architecture may be used to alleviate these problems for practical HDR imaging. In the following, the row-wise reset architecture to capture differently exposed images while the readout architecture is kept as the conventional one will be described.

Let t_{r,k} (y), t_{s,k} (y) and t_{e,k} (y) be the readout time, the reset time, and the exposure time of the y-th row in the k-th image. Suppose that the readout time of each row is ∇tᵣ. The value of t_{r,k}(y) is given as

t_{r,k}(y)=t_{0,k}+y∇tᵣ (6)

where t_{0,k} is the starting readout time of the first row in the k-th image.

It will be understood that the readout architecture may be the same as the existing readout architecture while the reset architecture is changed as follows:

t_{s,k}(y)=t_{r,k}(y)−t_{e,k}(y) (7)

where the value of t_{e,k} (y) needs to be determined according to the number of different exposures. For example, consider the case that there are three different exposures. Let τₛ, τₘ and τₗ be the short exposure time, the medium exposure time and the long exposure time, respectively. The values of t_{e,k} (y) are, with k being any integer number, defined as

$${t}_{e , k} ( y ) = \{ \begin{matrix}{τ}_{s} ; & if y = 3 n \\ {τ}_{m} ; & if y = 3 n + 1 \\ {τ}_{l} & otherwise\end{matrix} \qquad ( 8 )$$

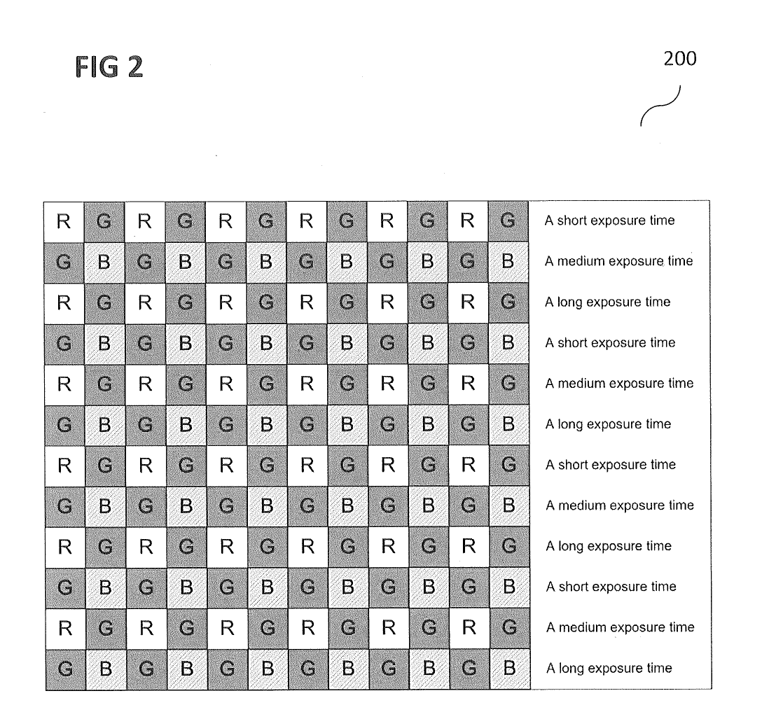

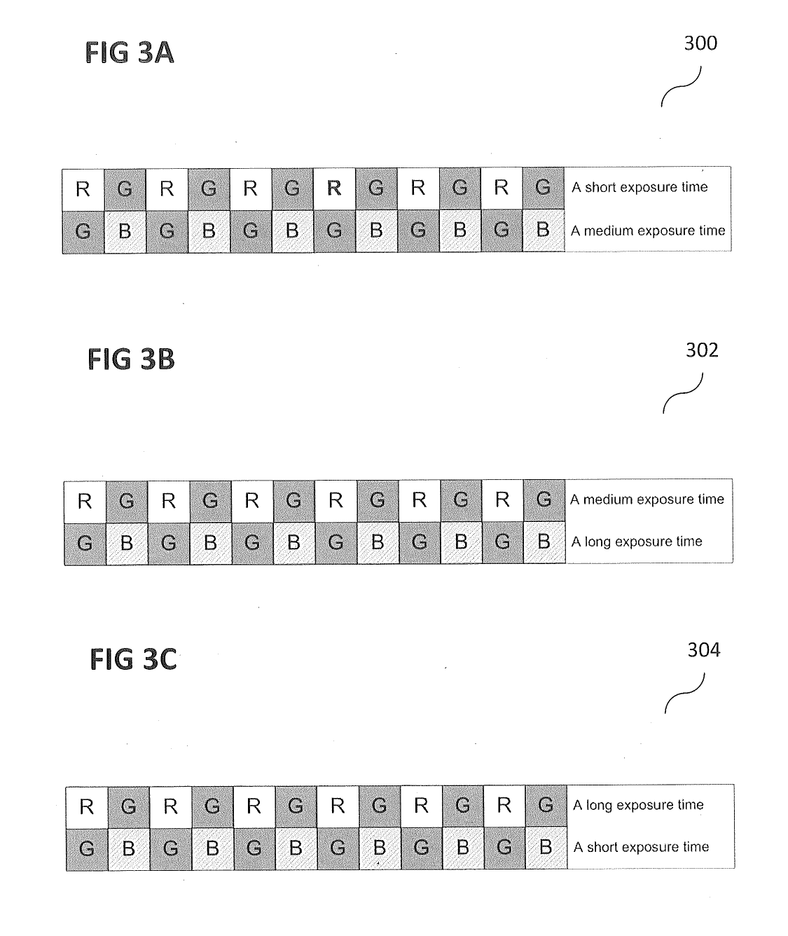

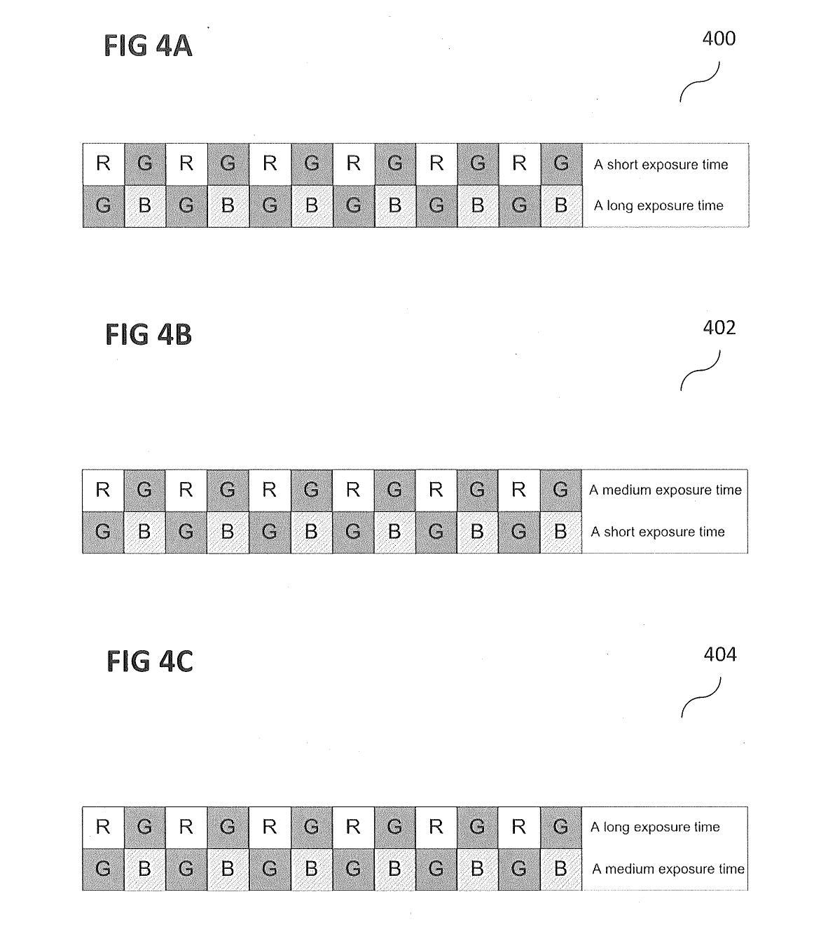

An example is shown in FIG. 2 that such a combination of row-wise exposure times are determined by using three basic patterns in FIG. 3A, FIG. 3B, and FIG. 3C. It is to be noted that there are many different combinations of three different exposures, and three additional basic patterns in FIG. 4 may be desired to construct other combination.

In FIG. 2, FIG. 3A, FIG. 3B, FIG. 3C, FIG. 4A, FIG. 4B, and FIG. 4C, “R” indicates a pixel configured to sense red light, “G” a pixel configured to sense green light, and “B” a pixel configured to sense blue light.

FIG. 2 shows an illustration 200 of an image with three row-wise different exposures, in which for example the rows have a sequence of short exposure time, followed by medium exposure time, followed by long exposure time, again followed by short exposure time. [0055]. FIG. 3A, FIG. 311, and FIG. 3C show illustrations of three basic Bayes color filter arrays with different exposures. FIG. 3A shows an illustration 300 of a first pattern (which may also be referred to as Pattern 1, for example short exposure time followed by medium exposure time). FIG. 3B shows an illustration 302 of a second pattern (which may also be referred to as Pattern 2, for example medium exposure time followed by long exposure time). FIG. 3C shows an illustration 304 of a third pattern (which may also be referred to as Pattern 3, for example long exposure time followed by short exposure time).

FIG. 4A, FIG. 4B, and FIG. 4C show illustrations of three additional basic Bayes color filter arrays with different exposures. FIG. 4A shows an illustration 400 of a fourth pattern (which may also be referred to as Pattern 4, for example short exposure time followed by long exposure time). FIG. 4B shows an illustration 402 of a fifth pattern (which may also be referred to as Pattern 5, for example medium exposure time followed by short exposure time). FIG. 4C shows an illustration 404 of a sixth pattern (which may also be referred to as Pattern 6, for example long exposure time followed by medium exposure time).

According to various embodiments, HDR imaging methods and device and exposure fusion methods and device may be provided which select the largest exposed images without motion blurring artefacts as the reference image. Besides considering the exposedness, of each pixel, the consistence between each pixel in other image and its collocated pixel in the reference image is taken into consideration according to various embodiments. As such, according to various embodiments, ghosting artefacts or motion blurring artefacts may be avoided from appearing in final images.

According to various embodiments, HDR imaging methods and devices and exposure fusion methods and devices may be provided. They can avoid ghost artefacts and motion blurring artefacts from appearing in final images. The devices and methods may be very useful for HDR video.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. An image processing device comprising:
an input circuit configured to receive input image data comprising pixels related to varying exposure times;
a selecting circuit configured to select a reference image from the input images;
a weighting determination circuit configured to determine at least one weighting for each pixel of the input image data based on the selected reference image;
an output image determination circuit configured to determine an output image based the determined weightings; and
an output circuit configured to output the output image.

2. The image processing device of claim 1,
wherein the weighting determination circuit is configured to determine an exposedness level weighting and a similarity weighting.

3. The image processing device of claim 1,
wherein one of the input images is selected as the reference image, and the weighting determination circuit is configured to determine a similarity weighting of all pixels in the input images with respect to the reference image.

4. The image processing device of claim 3,
wherein the similarity weighting of a pixel is close to one if the pixel and its collocated pixel in the reference image are consistent.

5. The image processing device of claim 3,
wherein the similarity weighting of a pixel is close to zero if the pixel and its collocated pixel in the reference image are not consistent.

6. The image processing device of claim 1,
wherein the output image determination circuit is configured to determine the output image based on a radiance map and a selected reference image.

7. The image processing device of claim 1,
wherein the input image data comprises an input image comprising rows, wherein the exposure time varies amongst the rows.

8. The image processing device of claim 1,
wherein the input image data comprises a plurality of images, wherein each image of the plurality of images has an exposure time, wherein the exposure time varies amongst the images of the plurality of images.

9. The image processing device of claim 1,
wherein the image processing device is configured to convert an input image of the input image data from RGB color space to CIELab color space.

10. The image processing device of claim 9,
wherein the image processing device is configured to fuse a lightness component of the converted image using a multi-scale method and to fuse color components of the converted image via a single-scale method.

11. An image processing method comprising:
receiving input image data comprising pixels related to varying exposure times;
selecting one of the input images as a reference image;
determining at least one weighting for each pixel of the input image data;
determining an output image based the determined weightings; and
outputting the output image.

12. The image processing method of claim 11,
wherein the at least one weighting comprises an exposedness level weighting and at least one weighting comprises a similarity weighting.

13. The image processing method of claim 11,
wherein the similarity weighting of a pixel is close to one if the pixel and its collocated pixel in the reference image are consistent.

14. The image processing method of claim 11,
wherein the similarity weighting of a pixel is close to zero if the pixel and its collocated pixel in the reference image are not consistent.

15. The image processing method of claim 11, further comprising:
determining the output image based on a radiance map and a selected reference image.

16. The image processing method of claim 11,
wherein the input image data comprises an input image comprising rows, wherein the exposure time varies amongst the rows.

17. The image processing method of claim 11,
wherein the input image data comprises a plurality of images, wherein each image of the plurality of images has an exposure time, wherein the exposure time varies amongst the images of the plurality of images.

18. The image processing method of claim 11, further comprising:
converting an input image of the input image data from RGB color space to CIELab color space.

19. The image processing method of claim 18, further comprising:
fusing a lightness component of the converted image using a multi-scale method, and fusing color components of the converted image via a single-scale method.
